(19) United States
(12) Patent Application Publication
(10) Pub. No.: US 2003/0023672 A1
(43) Pub. Date: Jan. 30, 2003

(54) Voice over IP conferencing server system with resource selection based on quality of service

(76) Inventor: Arthur Vaysman, Fremont, CA (US)

Correspondence Address: Timothy P. O'Hagan, PO Box 1054, Portsmouth, NH, 03802, US

(21) Appl. No.: 09/917,142

(22) Filed: Jul. 27, 2001

(51) Int. Cl. G06F 15/16

(52) U.S. Cl. 709/203; 709/228

(57) ABSTRACT

An Internet telephony conferencing system and an Internet video telephony conferencing system includes a plurality of conferencing servers, each controlling a plurality of conferencing bridges. Each bridge is configured to host an Internet telephony conference call or Internet video conference call between two or more telephony clients. Each client is configured to select a conferencing server for initiating the conference call based on a measurement of network quality of service between the client and the conferencing server.

### TECHNICAL FIELD

The present invention generally relates to voice over IP conferencing systems and more particularly, to an apparatus and method for selecting one of a plurality of voice over IP conferencing servers for use initiating and completing a voice over IP conference call between two or more participants.

### BACKGROUND OF THE INVENTION

For many years voice telephone service was implemented over a circuit switched network commonly known as the public switched telephone network (PSTN) and controlled by a local telephone service provider. In such systems, the analog electrical signals representing the conversation are transmitted between the two telephone handsets on a dedicated twisted pair copper wire circuit. More specifically, each telephone handset is coupled to a local switching station on a dedicated pair of copper wires known as a subscriber loop. When a telephone call is placed, the circuit is completed by dynamically coupling each subscriber loop to a dedicated pair of copper wires between the two switching stations.

More recently, the copper wires, or trunk lines between switching stations have been replaced with fiber optic cables. A computing device digitizes the analog signals and formats the digitized data into frames such that multiple conversations can be transmitted simultaneously on the same fiber. At the receiving end, a computing device reforms the analog signals for transmission on copper wires. Twisted pair copper wires of the subscriber loop are still used to couple the telephone handset to the local switching station.

More recently yet, voice telephone service has been implemented over the Internet. Advances in the speed of Internet data transmissions and Internet bandwidth have made it possible for telephone conversations to be communicated using the Internet's packet switched architecture and the TCP/IP protocol.

Software is available for use on personal computers which enable the two-way transfer of real-time voice information via an Internet data link between two personal computers (each of which is referred to as an end point), each end point computer includes appropriate hardware for driving a microphone and a speaker. Each end point operates simultaneously as both a sender of real time voice data and as a receiver of real time voice data to support a full duplex voice conversation. As a sender of real time voice data, the end point computer converts voice signals from analog format, as detected by the microphone hardware, to digital format. The software then facilitates data compression down to a rate compatible with the end point computer's data connection to an Internet Service Provider (ISP) and facilitates encapsulation of the digitized and compressed voice data into the TCP/IP protocol, with appropriate addressing to permit communication via the Internet.

As a receiver of real time voice data, the end point computer and software reverse the process to recover the analog voice information for presentation to the other party via the speaker associated with the receiving computer.

To promote the wide spread use of Internet telephony, the International Telephony Union (ITU) had developed a set of standards for Internet telephony. The ITU Q.931 standard relates to call signaling and set up, the ITU H.245 standard provides for negotiation of channel usage and capabilities between the two endpoints, and the ITU H.323 standard provides for real time voice data between the two end points to occur utilizing User Datagram Protocol (UDP) frames to deliver the real time voice data. More recently yet, other protocols such as SIP and MGCP have been developed to further expand Internet telephony applications, devices, and systems.

One problem associated with Internet telephony between two endpoint computers is that it is not well suited for three way calls or conference calls with three or more participants. More specifically, the requirement that each caller be able to speak to and hear each other caller would require voice streams from each caller to be sent to each other caller. As such, conferencing servers have been developed. A conferencing server operates as a hub and maintains a peer to peer Internet telephony call with each conference participant and mixes the voice streams of the various participants to provide for all participants to talk to and hear all other participants.

Another problem associated with Internet telephony is poor voice quality caused by network latency and packet loss. Network latency is the delay time between when a packet of data is sent by the sending endpoint computer until it is received by the receiving endpoint computer. Because voice data is real time data, network latency can cause a significant delay between when the speaker talks and when a listener hears the speaker at the other endpoint computer. The delay caused by network latency is further exacerbated in a conferencing server configuration wherein total latency is equal to latency in sending from the speaker Internet endpoint computer to the server, latency in mixing the various voice streams at the server, and latency in sending from the server to the listener's endpoint computer.

Packet loss is the failure of a receiving device to receive a frame sent by a sending device. Packet loss typically occurs in a congested network when buffers begin to overflow in the routers between the sending device and the receiving device. Packet loss can also occur in a conferencing server system if the conferencing server is overloaded or buffers for inbound packets overflow at the conferencing server. In an Internet telephony conversation, packet loss between either the speaker's endpoint and the server or between the server and the listener's endpoint will cause the listener to hear breaks in the speakers speech.

What is needed is a conferencing server system which enables multiple conference call participants to participate in Internet telephony conferences and/or Internet video conferences with each other. Further, what is needed is a conferencing server system which provides for selecting a conference server for initiating and completing an Internet telephony conference in a manner which optimizes use of conference server resources and optimizes the quality of service for participants on the call.

### SUMMARY OF THE INVENTION

A first aspect of the present invention is to provide an Internet telephony conferencing server system comprising a plurality of conferencing centers. Each conferencing center is configured for hosting a conference call amongst a plurality of telephony clients. Each telephony client is configured to measure at least one quality of service characteristic of communication with each conferencing center and to select one of the conferencing centers based on the quality of service characteristic for hosting a conference call.

The telephony client may measure at least one quality of service characteristic by sending a plurality of ping packets to a conferencing server at each conferencing center, receiving a plurality of ping response packets, and measuring latency time and packet loss for each conferencing server. The telephony client may then select the one of the conferencing centers by selecting the conferencing server providing the lowest packet loss and if two or more servers have the lowest packet loss, selecting the one of such two or more servers which has the lowest latency time.

Each telephony client may exchange only audio data with the one of the selected conferencing centers or may exchange both audio data and video data with the selected one of the conferencing centers.

A second aspect of the present invention is to provide an internet telephony client for participating in Internet telephony conference calls hosted by a conferencing bridge. The client comprises an audio interface for: i) receiving microphone input of an operator speaking and generating digital audio data; and ii) receiving digital audio data representing a remote voice stream and generating an analog audio signal driving a speaker.

The client also includes an Internet telephony application for: i) measuring at least one quality of service characteristic of each of a plurality of conferencing servers and selecting the one of the conferencing servers which provides the highest quality of service characteristic for hosting a conference call; ii) compressing the digital audio data into a sequence of UDP datagrams for sending to the selected conferencing server; and iii) decompressing a sequence of UDP datagrams from the selected conferencing server to generate the digital audio data representing the remote voice stream.

The client may further include a video interface for receiving video camera input and for receiving digital video data representing remote video camera input via the Internet telephony application. The video interface generates a video signal for driving a monitor. The Internet telephony application would then further operate for compressing the video camera input into a sequence of UDP datagrams for sending to the selected conferencing server and decompressing a sequence of UDP datagrams from the selected conferencing server to generate the video signal.

The Internet telephony application may measure the quality of service characteristic by sending a plurality of ping packets to each conferencing server, receiving a plurality of ping response packets, and measuring latency time and packet loss for each conferencing server. The telephony application may then select one of the conferencing servers by selecting the conferencing server providing the lowest packet loss and if two or more servers have equivalent packet loss, selecting such two or more servers which has the lower latency time.

The UDP datagrams representing the digital audio data may be sent to the selected conferencing server and the UDP datagrams representing the remote voice stream may be received from the selected conferencing server during an Internet telephony media session. The application sets up the media session by sending or receiving a signaling request and by negotiating UDP channels for sending and receiving UDP datagrams. More specifically, the signaling request may be a Q.931 signaling request and wherein the UDP channel negotiation may be compliant with an H.245 protocol.

A third aspect of the present invention is to provide a method of initiating an Internet telephony conference call. The method comprises measuring at least one quality of service characteristic of each of a plurality of conferencing servers and initiating the Internet telephony conference call to one of the conferencing servers based on the quality of service characteristic for hosting a conference call.

The step of initiating the Internet telephony conference call may include selecting the conference server providing the best quality of service by sending a plurality of ping packets to each conferencing server, receiving a plurality of ping response packets, and measuring latency time and packet loss for each conferencing server. Then, the conference server may be selected by selecting the one with the lowest packet loss and if two or more servers have the lowest packet loss, selecting one of such two or more servers which has the lower latency time.

The step of initiating the conference call may further include sending a list of call participants to the conference server such that a conference bridge associated with the conference server can establish an Internet telephony session with each call participant.

The step of establishing an Internet telephony session may include opening a Q.931 signaling connection, opening an H.245 session, and negotiating UDP datagrams channels for sending and receiving UDP datagrams representing conference audio streams.

### BRIEF DESCRIPTION OF THE DRAWINGS

FIG. 1 is a block diagram of an Internet telephony conferencing system in accordance with this invention;

FIG. 2 is a block diagram of an Internet telephony client in accordance with one embodiment of this invention;

FIG. 3 is a flow chart showing exemplary operation of an a client telephony application in accordance with one embodiment of this invention;

FIG. 4 is a block diagram of a conferencing bridge in accordance with one embodiment of this invention;

FIG. 5 is a flow chart showing exemplary operation of a conferencing bridge conferencing speaker verification system in accordance with one embodiment of this invention; and

FIG. 6 is a diagram showing a monitor view of exemplary video signal in accordance with one embodiment of this invention.

### DESCRIPTION OF THE PREFERRED EMBODIMENTS

The present invention will now be described in detail with reference to the drawings. In the drawings, like reference numerals are used to refer to like elements throughout.

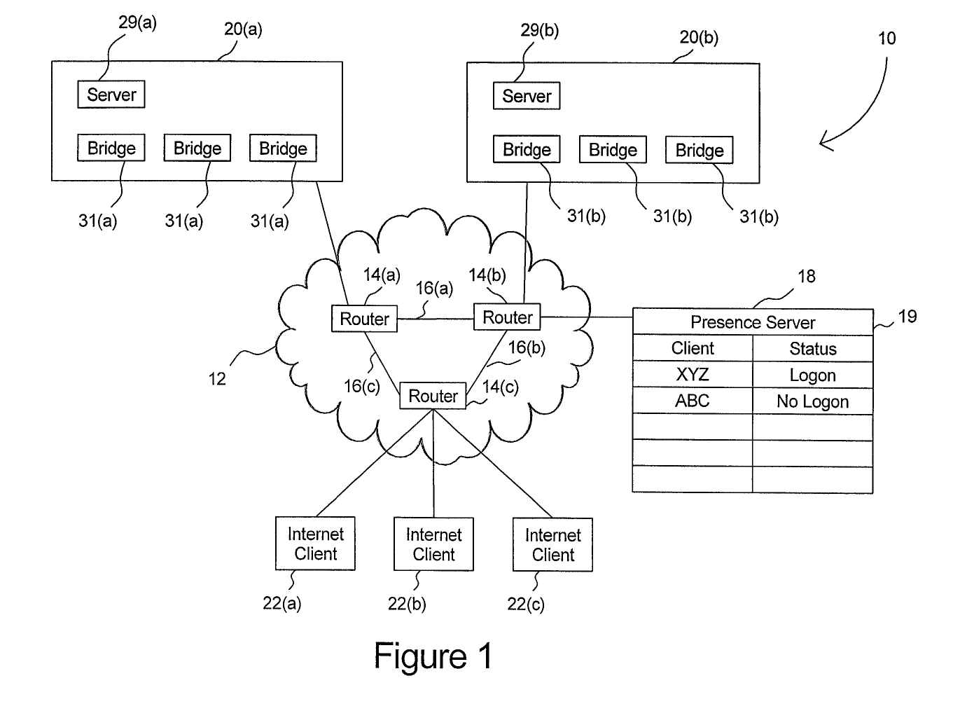

FIG. 1 represents a block diagram of a telephony conference server system 10 utilizing the Internet 12. The Internet 12 includes a plurality of routers 14(a) 14(c) interconnected by high speed data links 16(a)-16(c).

Coupled to the Internet 12, or more specifically coupled to one of the routers 14(a)-14(c), are various computing devices that, for purposes of this invention, include a presence server 18, a plurality of conferencing centers 20(a) and 20(b), and a plurality of telephony clients 22(a)-22(c).

Each of the conferencing centers 20(a) and 20(b) includes a conferencing server 29(a) and 29(b) respectively and a plurality of conferencing bridges 31(a) and 31(b) respectively. Each of the conferencing bridges 31(a) and 31(b) is configured to host an Internet telephony conversation, or an Internet video conference, between the operators of two or more of the telephony clients 22(a), 22(b), 22(c) under control of the conferencing server 29(a) and 29(b) respectively. (The term “conference call” as used in this specification is intended to include both Internet telephony conversations and Internet video conferences.) More specifically, a conferencing server (server 29(a) for example) is configured to receive a conference call set up request from an initiating telephony client (client 22(a) for example) and based on resource balancing amongst the conference bridges 31(a) select a particular one of the bridges 31(a) for hosting the conference call. The selected bridge 31(a) then sets up an Internet telephony session with each of the participating telephony clients 22(a), 22(b), and/or 22(c). Setting up each Internet telephony session may include receiving and responding to a session signaling request from the client 22(a), 22(b), 22(c) or may include initiating a session signaling request to the telephony client 22(a), 22(b), 22(c). More detail on session signaling is included later herein. After all sessions are set up, and continuing through the duration of the conference call, the selected bridge 31(a) receives a voice stream (and optionally a video stream) from each participating client 22(a), 22(b), 22(c), mixes the voice streams, and returns a mixed voice stream back to each participating client 22(a), 22(b), and 22(c) representing the conference call. The selected bridge 31(a) may also mix the video streams in a manner such that a single video monitor signal may display multiple sub-pictures, each sub-picture representing a video camera input from a remote participating telephony client 22(a), 22(b), and 22(c). A more detailed discussion of the bridge 31(a), 31(b) and the operation of mixing the audio streams and the video streams with varying numbers of participants is included later herein.

The presence server 18 maintains a presence table 19 which includes the identity of each of the telephony clients 22(a), 22(b), 22(c) and an indication of whether each client 22(a), 22(b), 22(c) is currently logged onto the Internet 12. As will be discussed in more detail herein, each of the clients 22(a), 22(b), 22(c) is configured to register with the presence server 18 at login such that the presence server 18 may maintain the accuracy of the presence table 19. Once registered, the client 22(a), 22(b), 22(c) is able to initiate and participate in Internet telephony conference calls hosted by any one of the bridges 31(a), 31(b).

Each telephony client 22(a), 22(b), 22(c) is also configured to select the conference center 20(a) or 20(b) which will provide the highest quality of service for conference calls at login. More specifically, at login, the telephony client 22(a), 22(b), 22(c) will ping each conference server 29(a) and 29(b) to measure latency and packet loss. The conference server 29(a) or 29(b) which provides the lowest latency and packet loss will be deemed to provide the best quality of service and will be selected for conference calls.

For initiating a conference call, each telephony client 22(a), 22(b), 22(c) is configured to interrogate the presence server 18 to obtain, and display to the operator, at least a portion of the presence table as an “associate list”, “buddy list®”, or other directory list of other clients 22(a), 22(b), 22(c) which are currently logged on and available to participate in an Internet telephony conference call. The telephony client 22(a), 22(b), 22(c) is further configured to enable the operator to select one or more other participants from such directory list and to initiate the conference call by sending a conference call set up request to the selected conference server 29(a) or 29(b).

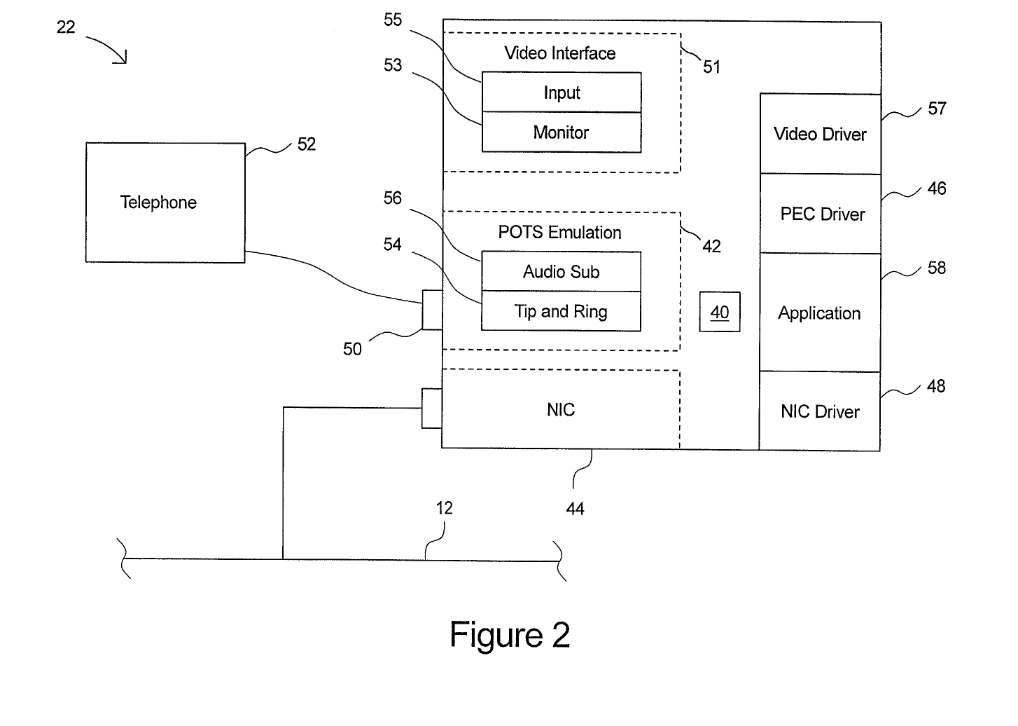

Referring to FIG. 2, exemplary structure of a telephony client 22 is shown. The telephony client 22 may be a desk top computer which includes a processing unit 40 for operating a plain old telephone service (POTS) emulation circuit 42, a video I/O interface circuit 51, a network interface circuit 44, a driver 46 for the POTS emulation circuit 42, a driver 57 for the video I/O circuit 51, a driver 48 for the network interface circuit 44, and an Internet telephony application 58. Each of the POTS emulation circuit 42, video I/O interface circuit 51, and the network interface circuit 44 may be cards that plug into the computer expansion slots.

Alternatively, other configurations of a telephony client 22 are envisioned which include all of the above systems embedded therein. Other configurations include, but are not limited to, an Internet telephony appliance structured as a network interface home telephone, a gaming device, or another consumer product with Internet telephony capabilities coupled to the Internet 12 (FIG. 1) via a wired or wireless connection such as the cellular telephone network, the PCS network, or other wide area RF network.

In the exemplary embodiment, the network interface circuit 44 and the network interface driver 48 together include the hardware and software circuits (including the IP stack) for operating the TCP/IP and UDP/IP protocols for communicating datagrams over the Internet 12.

The POTS emulation circuit 42 includes an RJ-11 female jack 50 for coupling a traditional POTS telephone handset 52 to the emulation circuit 42. A tip and ring emulation circuit 54 emulates low frequency POTS signals on the tip and ring lines for operating the telephone handset 52. An audio system 56 interfaces the tip and ring emulation circuit 54 with the Internet telephony application 58. More specifically, the audio system 56 operates to digitize audio signals from the microphone in the handset 52 and present a digital audio signal to the Internet telephony application 58, and simultaneously, operates to receive a digital audio signal from the Internet telephony application 58 (representing the voices of the other call participants), convert the digital audio signal to an analog audio data, and present the analog audio signal to the tip and ring emulation circuit 54. The tip and ring emulation circuit 54 modulates the tip and ring lines for driving the speaker of the handset 52 in accordance with the analog signal received from the audio system 56.

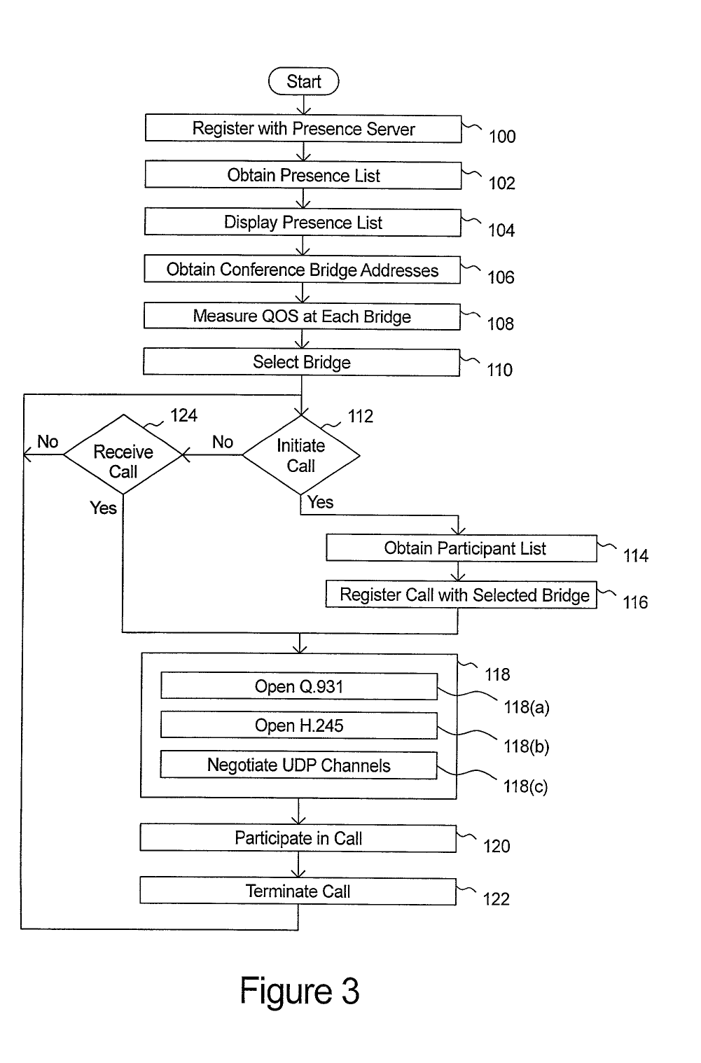

The video I/O interface circuit 51 includes a video camera input circuit 55 for receiving a video camera (not shown) input signal, digitizing the video signal from the camera, and presenting the digital video signal to the Internet telephony application 58. The video I/O circuit 51 also includes a monitor output circuit 53 for generating a video signal for driving a video monitor (not shown) in accordance with a digital video signal received from the Internet telephony application 58. As discussed above, the telephony client 22 is configured to register with the presence server 18 (FIG. 1) at login, participate in conference calls, and initiate conference calls (including bridge selection). Such functions are performed by the telephony application 58. Referring to the flowchart of FIG. 3 in conjunction with the block diagram of FIG. 1, exemplary operation of the telephony application 58 is shown. For purpose of illustration, operation of the telephony application of client 22(a) is herein discussed.

Step 100 represents registering the client 22(a) with the presence server 18. The presence server 18 maintains the presence table 19 which identifies each of the telephony clients 22(a), 22(b), 22(c) and indicates whether each is currently logged onto the Internet 12. The step of registering the client 22(a) with the presence server 18 enables the presence server to update the presence list to reflect the client 22(a) being logged onto the Internet 12.

Step 102 represents interrogating the presence server to obtain the presence table 19, or to at least obtain a list of other clients 22(b), 22(c) that are currently logged onto the Internet. Step 104 represents displaying the presence list to the operator of the client 22(a). This enables the operator to view which of his or her associates are currently logged onto the Internet 12 and are available to participate in a conference call.

Step 106 represents obtaining the IP address of each conference server 29(a) and 29(b) from the presence server. This provides the client 22(a) with the virtual location of each of the conferencing centers 20(a) and 20(b) available for hosting Internet telephony conferences. Step 108 then represents pinging each conference server 29(a) and 29(b) to measure the quality of service (QOS) provided by each. More specifically, the client 22(a) will ping each conference server 29(a) and 29(b) a plurality of times to measure latency time and packet loss. Step 110 then represents selecting the conference server 29(a) or 29(b) which has the best QOS. More specifically, step 110 represents determining which of the plurality of conference servers 29(a), 29(b) provides the lowest packet loss. If one of the plurality of conference servers 29(a), 29(b) provides the lowest packet loss, such server is determined to provide the best QOS. However, if two or more of the plurality of conference servers 29(a), 29(b) have equally low packet loss levels, the one of such servers with the low packet loss which also has the lowest latency time will be determined to provide the best QOS.

After a conference server 29(a) or 29(b) is selected, the client 22(a) is ready for the operator to initiate a conference call. This state is represented in flowchart form by the loop from step 112 to 124 and back to 112. The loop being broken at either step 112 or 124 if the operator initiates a call or a call is receive respectively.

Step 112 represents determining whether the operator of the client 22(a) desires to initiate a conference call to one or more of the other clients 22(b) and/or 22(c). Typically the operator will operate a screen control or a button on the client 22(a) to indicate that he or she wishes to initiate a call. If the operator desires to initiate a call, step 114 represents obtaining a list of participants from the operator of the client 22(a). Typically the operator will use a screen control or buttons to select one or more of the other clients 22(b), 22(c) which are currently logged onto the Internet 12 to participate in the conference call.

Step 116 represents sending a conference call set up request to the selected conference server (server 29(a) for example). In response the selected server 29(a) will select a particular one of the conference bridges 31(a) for operating the call based on load balancing at each conferencing center 20(a) and provide the selected bridge with a list of the call participants. This enables the selected bridge 31(a) to set up Internet telephony sessions with each of the selected clients.

Step 118 represents the client 22(a) setting up a telephony session with the selected bridge 31(a) for participating in the conference call. More specifically, sub step 118(a) represents establishing a Q.931 TCP/IP connection with the selected bridge 31(a). The Q.931 connection is utilized to exchange Q.931 messages which includes opening an H.245 connection between the client 22(a) and the selected bridge 31(a) at sub step 118(b). The H.245 connection is utilized to exchange H.245 messages which includes negotiating UDP channel usage for transferring audio data (and video data) in full duplex between the client 22(a) and the selected conferencing bridge 31(a) at sub step 118(c). Each UDP channel is defined by the IP address and logical port number of the sending device (“Source Address”) and the IP address and logical port number of the receiving device (“Destination Address”).

Step 120 then represents participating in the conference call. More specifically with respect to audio data, Step 120 represents: a) compressing digital audio data and sending a sequence of UPD datagrams, representing the voice of the operator of the client 22(a), to the selected bridge 31(a) on the negotiated UDP channel (e.g. the Destination Address identified by the bridge 31(a) for receiving UDP datagrams and the Source Address of the client 22(a) identified by the client 22(a) for sending UDP datagrams); and (b) receiving a sequence of UDP datagrams, representing a mix of the voices of the other call participants, from the bridge 31(a) on the negotiated UDP channel and decompressing to generate digital audio data.

With respect to video data, Step 120 represents: a) compressing digital video data and sending a sequence of UPD datagrams, representing the video signal of the camera coupled to the client 22(a), to the selected bridge 31(a) on the negotiated UDP channel; and (b) receiving a sequence of UDP datagrams, representing a conference video signal from the bridge 31(a) on the negotiated UDP channel and decompressing to generate a digital video signal for driving the monitor.

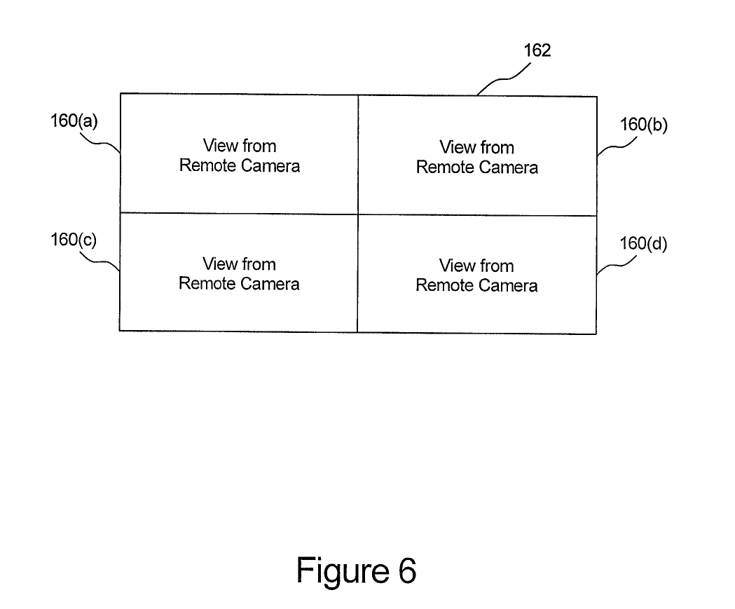

Referring briefly to FIG. 6, the conference video signal may be a signal with multiple sub-pictures 160(a), 160(b), 160(c), and 160(d) within the video picture 162. Each of the multiple sub-pictures 160(a), 160(b), 160(c), and 160(d) may represent the view captured by a video camera coupled to one of the other remote participating clients. In the exemplary embodiment, the Internet telephony application 58 of the client may enable the operator to select: a) how many sub-pictures 160(a), 160(b), 160(c), and 160(d) are viewed simultaneously; and b) which remote video camera view is represented by each sub-picture 160(a), 160(b), 160(c), and 160(d).

After the conference call is complete, step 122 represents terminating the Internet telephony session between the client 22(a) and the bridge 31(a) and the system proceeds back to step 112.

If at step 112, the client 22(a) does not to initiate a call, step 124 represents receiving a call from a bridge such that the client 22(a) is to participate in a conference initiated by another of the clients 22(b) or 22(c). More specifically, step 114 represents a determination of a Q.931 set up request being received on the well known port number established by the client 22(a) for receipt of Q.931 connection request. If yes, the client 22(a) again proceeds to steps 118,120, and 122 wherein the Internet telephony session is set up with the bridge 31(a), the caller participates in the conference call via the sending and receiving of sequences of UDP datagrams, and the session is terminated respectively.

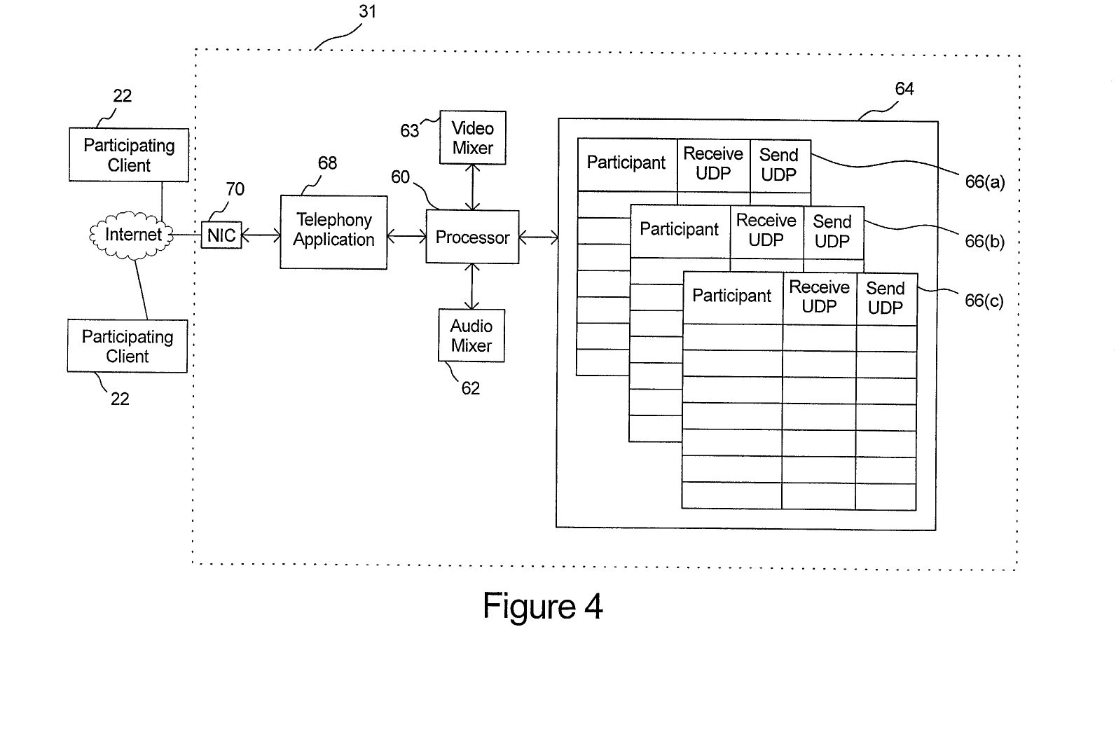

FIG. 4 represents a block diagram of the telephony bridge 31. The bridge 31 includes a network interface circuit 70 and a telephony application 68 for communicating frames of data over the Internet 12 with each of the telephony clients 22 which participate in a conference call. More specifically, for each of the telephony clients 22, the telephony application 68: 1) decompresses a sequence of received UDP datagrams from such telephony client to a digitized raw audio signal, or voice stream, of the operator of such telephony client 22 speaking; 2) decompresses a sequence of received UDP datagrams from such telephony client to a digitized raw video signal, or video stream, of the camera associated with such telephony client 22 speaking; 3) compresses digitized raw audio signal(s) representing an audio mix of the other conference call participant(s) to a sequence of UPD datagrams for sending to such telephony client 22; and 4) compresses digitized raw video signal(s) representing a video mix of the selected sub-pictures for sending to such telephony client 22.

The bridge 31 includes an open calls data base 64 which includes a participant table 66(a), 66(b), and 66(c) for each open call. Each participant table 66(a), 66(b) and 66(c) includes the identity of each client 22 which is participating on the particular call. The participant table 66(a), 66(b), 66(c) also includes the UDP channel utilized for receiving UDP datagrams from the participating client 22, and the UDP channel utilized for sending UDP datagrams to the participating client 22.

The bridge 31 further includes an audio mixing circuit 62. For each hosted conference call, the audio mixing circuit 62 mixes the voice streams of the conference participants to generate the audio mix(es) of conference call participants. For each conference with up to four participants, up to 4 distinct audio mixes will be generated, one for each participant. Each participant will receive an audio mix that includes all of the other participants on the conference call but does not include such participant. As such, no participant will hear his or her own voice on the mix as an echo.

For conferences with 5 or more participants, a total of four distinct audio mixes will be generated. The first audio mix will be a mix of the 3 loudest participant voice streams. Because participants will in theory take turns talking and interrupting each other, the set of three loudest participants at any certain time may be a different set of participants than those that are the three loudest a fraction of a second later. As such, the mix is actually a sequence of mixes, each mix being made over a very brief time period (on the order of milliseconds) and including a mix of the three loudest voice streams during such brief time period.

During each brief time period, the first audio mix can not be sent to the three loudest participants whose voice steams are used to generate the mix. As such, three other audio mixes are also generated for each brief time period. Each of the three other audio mixes is the same as the first audio mix except it excludes one of the three voice streams and is thus suitable for sending to the participant whose voice stream is excluded.

The bridge 31 also includes a video mixing circuit 63. For each hosted conference call, the video mixing circuit 63 receives the video stream from each video camera coupled to a participating client 22. The video mixing circuit 63 generates a mixed video signal for each participating client. As shown in FIG. 6, the mixed video signal for each participating client 22 comprises a video signal for a picture 162 which includes each of the multiple pictures 160(a), 160(b), 160(c), and 160(d) and each of the multiple sub-pictures 160(a), 160(b), 160(c), and 160(d) selected by such client.

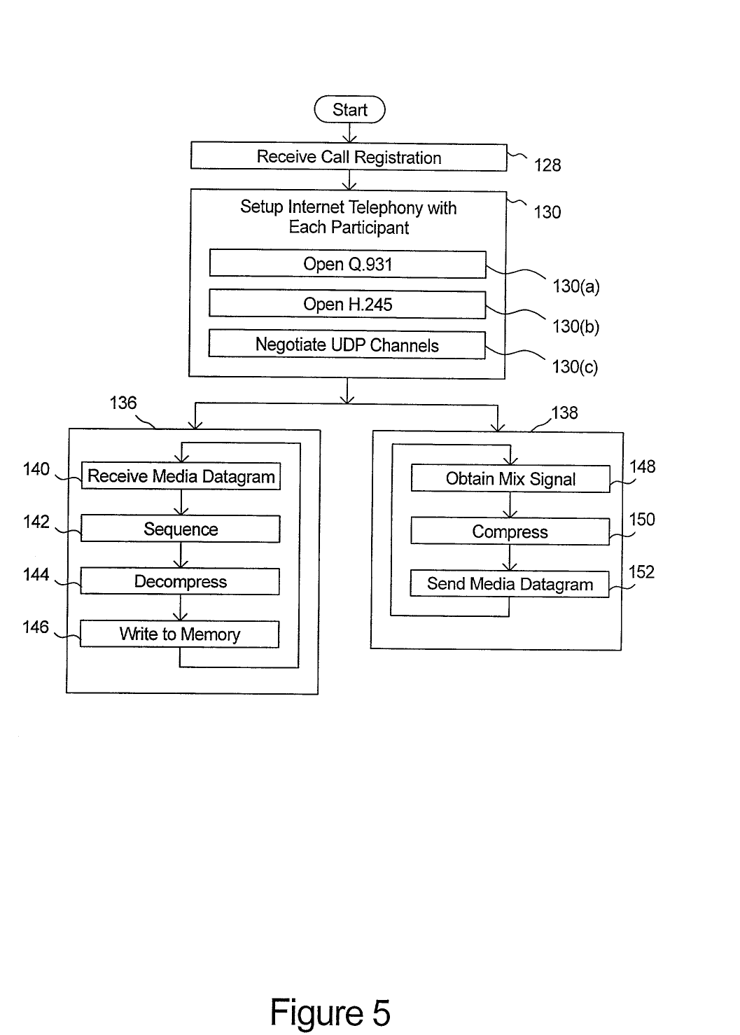

As discussed above, an Internet telephony session is set up between the bridge 31 and each of the participating telephony clients 22. As such, the telephony application 68 is configured to receive UDP datagrams from the client 22 and send UDP datagrams to the client 22 to effectively maintain the conference call with each client 22. Turning to the Flowchart of FIG. 5, exemplary operation of the telephony application 68 is shown.

In the exemplarily embodiment, step 128 represents receiving a list of participating clients 22(a), 22(b), and 22(c) from the conference server 29(a) or 29(b). Step 130 then represents setting up an Internet telephony sessions with each participating client 22(a), 22(b), and 22(c). More particularly, step 130 includes sub step 130(a) which represents responding to a Q.931 connection request on a well known port for opening Q.931 connections and effectively opening a TCP/IP connection with the client 22 for the exchange of Q.931 call signaling messages if the client 22(a), 22(b), or 22(c) is initiating the Internet telephony session. Alternatively sub step 130(a) represents sending a Q.931 connection request to the client 22(a), 22(b), or 22(c) if the bridge 31 is initiating the telephony session. Once opened, the Q.931 connection is then utilized to exchange Q.931 messages which includes opening an H.245 connection between the client 22(a) and the bridge 31(a) at sub step 130(b). The H.245 connection is utilized to exchange H.245 messages which includes negotiating UDP channel usage for transferring audio data and video data in full duplex between the client 22(a) and the bridge 31(a) at sub step 130(c).

After an Internet telephony session is opened with each participating client 22(a), 22(b), and 22(c), steps 136 and 138 represents the media session wherein UPD datagrams are exchanged with each participating client 22(a), 22(b), and 22(c) representing the conference call. Step 136 represents receiving a sequence of UDP datagrams from a client and decompressing to generate a voice stream of the participant and to generate a video stream of the video camera associated with the participant. Step 138 represents compressing an audio mix and a video signal to sequences of UDP datagrams and sending to a client. To effectively host the conference call, the bridge 31 will perform, for each participating client 22(a), 22(b), and 22(c), steps 136 and 138 as parallel strings. Therefore, for purposes of the following discussion of steps 136 and 138 the client will be referenced as client 22.

With respect to receiving UDP datagrams, step 136 includes sub step 140 which represents receiving a UDP datagram from the client 22 on the port number established for receipt of UDP datagrams, sub step 142 which represents sequencing the UDP datagrams (which may be received out of order), sub step 144 which represents decompression to generate the voice stream and video stream, and sub step 146 which represents writing the voice stream and video stream to memory so that it may be retrieved by the mixer 62 (FIG. 4).

With respect to sending UDP datagrams, step 138 includes sub step 148 which represents receiving a portion of an audio mix signal for sending to the client 22 from the audio mixer 62 and which represents receiving a portion of a video signal for sending to the client 22 from the video mixer 63. Sub step 150 represents compressing the audio mix signal to generate a frame of compressed audio data for sending to the client 22 as a media datagram(s) and compressing the video signal to generate a frame of compressed video data for sending to the client 22 as media datagram(s). Sub step 152 represents sending the media datagrams to the client 22.

It should be appreciated that the systems and methods of this invention provides for the ability to establish and maintain Internet telephony conference calls between multiple clients utilizing a conference bridge providing the best quality of service. Additionally, although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

What is claimed is:

1. An Internet telephony conferencing server system comprising a plurality of conferencing centers, each configured for hosting a conference call amongst a plurality of the telephony clients, and wherein each telephony client is configured to measure at least one quality of service characteristic of communication with each conferencing center and to select one of the conferencing centers based on the quality of service characteristic for hosting a conference call.

2. The Internet telephony conferencing server system of claim 1, wherein each telephony client is configured to exchange both audio and video data with the selected one of the conferencing centers.

3. The Internet telephony conferencing server system of claim 2, wherein the telephony client measures the at least one quality of service characteristic by sending a plurality of ping packets to a conferencing server at each conferencing center, receiving a plurality of ping response packets, and measuring latency time and packet loss for each conferencing server.

4. The Internet telephony conferencing server system of claim 3, wherein the telephony client selects one of the conferencing centers by selecting the conferencing server providing the lowest packet loss and if two or more servers have the lowest packet loss, selecting the one of such two or more servers which has the lowest latency time.

5. The Internet telephony conferencing server system of claim 1, wherein the telephony client measures the at least one quality of service characteristic by sending a plurality of ping packets to a conferencing server at each conferencing center, receiving a plurality of ping response packets, and measuring latency time and packet loss for each conferencing server.

6. The Internet telephony conferencing server system of claim 5, wherein the telephony client selects one of the conferencing centers by selecting the conferencing server providing the lowest packet loss and if two or more servers have the lowest packet loss, selecting the one of such two or more servers which has the lowest latency time.

7. An Internet telephony client for participating in Internet telephony conference calls hosted by a conferencing bridge, the client comprising:
a) an audio interface for:
i) receiving microphone input of an operator speaking and generating digital audio data; and
ii) receiving digital audio data representing a remote voice stream and generating an analog audio signal driving a speaker;
b) an Internet telephony application for:
i) measuring at least one quality of service characteristic of each of a plurality of conferencing servers and selecting the one of the conferencing servers which provides the highest quality of service characteristic for hosting a conference call;
ii) compressing the digital audio data into a sequence of UDP datagrams for sending to the selected conferencing server; and
iii) decompressing a sequence of UDP datagrams from the selected conferencing server to generate the digital audio data representing the remote voice stream.

8. The Internet telephony client of claim 7, further including a video interface for receiving video camera input and for receiving digital video data representing remote video camera input via the Internet telephony application and generating a video signal for driving a monitor, and the Internet telephony application further operates S for compressing the video camera input into a sequence of UDP datagrams for sending to the selected conferencing server and decompressing a sequence of UDP datagrams for the selected conferencing server to generate the video signal.

9. The Internet telephony client of claim 8, wherein the application measures the quality of service characteristic by sending a plurality of ping packets to each conferencing server, receiving a plurality of ping response packets, and measuring latency time and packet loss for each conferencing server.

10. The Internet telephony client of claim 9, wherein the application selects one of the conferencing servers by selecting the conferencing server providing the lowest packet loss and if two or more servers have equivalent packet loss, selecting such two or more servers which has the lower latency time.

11. The Internet telephony client of claim 7, wherein the application measures the quality of service characteristic by sending a plurality of ping packets to each conferencing server, receiving a plurality of ping response packets, and measuring latency time and packet loss for each conferencing server.

12. The Internet telephony client of claim 11, wherein the application selects one of the conferencing servers by selecting the conferencing server providing the lowest packet loss and if two or more servers have equivalent packet loss, selecting such two or more servers which has the lower latency time.

13. The Internet telephony client of claim 12, wherein the UDP datagrams representing the digital audio data are sent to the selected conferencing server and the UDP datagrams representing the remote voice stream are received from the selected conferencing server during an Internet telephony media session and the application sets up the media session by at least one of sending and receiving a signaling request and by negotiating UDP channels for sending and receiving UDP datagrams.

14. The Internet telephony client of claim 13, wherein the signaling request is a Q.931 signaling request and wherein the UDP channel negotiating is compliant with an H.245 protocol.

15. A method of initiating an Internet telephony conference call, the method comprising:
a) measuring at least one quality of service characteristic of each of a plurality of conferencing servers; and
b) initiating the Internet telephony conference call to one of the conferencing servers based on the quality of service characteristic for hosting a conference call.

16. The method of initiating an Internet telephony conference call of claim 15, wherein the step of initiating the Internet telephony conference call includes selecting the conference server providing the best quality of service by sending a plurality of ping packets to each conferencing server, receiving a plurality of ping response packets, and measuring latency time and packet loss for each conferencing server.

17. The method of initiating an Internet telephony conference call of claim 16, wherein step of selecting the conferencing server providing the best quality of service includes selecting the conference server with the lowest packet loss and if two or more servers have the lowest packet loss, selecting one of such two or more servers which has the lower latency time.

18. The method of initiating an Internet telephony conference call of claim 17, wherein the step of initiating the conference call further includes sending a list of call participants to the conference server such that a conference bridge associated with the conference server can establish an Internet telephony session with each server.

19. The method of initiating an Internet telephony conference call of claim 18, wherein establishing an Internet telephony session includes opening a Q.931 signaling connection.

20. The method of initiating an Internet telephony conference call of claim 19, wherein establishing an Internet telephony session further includes opening an H.245 session.

21. The method of initiating an Internet telephony conference call of claim 20, wherein establishing an Internet telephony session further includes negotiating UDP datagrams channels for sending and receiving UDP datagrams representing conference audio streams.
